(19) United States
(12) Patent Application Publication
(10) Pub. No.: US 2023/0048851 A1
(43) Pub. Date: Feb. 16, 2023

(54) Golf Ball Tracking System and Method

(71) Applicant: Jocelyn Bruno, Cibolo, TX (US)

(72) Inventor: Jocelyn Bruno, Cibolo, TX (US)

(21) Appl. No.: 17/486,449

(22) Filed: Sep. 27, 2021

Related U.S. Application Data
(63) Continuation-in-part of application No. 17/401,271, filed on Aug. 12, 2021, now abandoned.

(51) Int. Cl. A63B 24/00; A63B 71/06; A63B 43/00; G01S 13/46; H04W 4/024; H04W 4/80

(52) U.S. Cl. CPC A63B 24/0021; A63B 71/0622; A63B 43/00; G01S 13/46; H04W 4/024; H04W 4/80; A63B 2024/0053; A63B 2071/0625; A63B 2225/50; G01S 2013/468

(57) ABSTRACT

A system and method for providing active golf ball location tracking according to the present invention is a hand-held device having a memory having instructions stored thereon, a display device, and a processor configured to execute the instructions on the memory to cause the hand-held device to establish a connection with a first golf ball among the plurality of golf balls, load a data buffer containing a unique ID into the first golf ball, periodically determine a current position of the first golf ball until the current position begins to change, receive cellular network tower signals associate with the first golf ball, periodically triangulate a moving position of the first golf ball using the cellular network tower signals, when the moving position of the first golf ball stops changing, determine a range and direction of the first golf ball from the hand-held device; and display the range and direction of the first golf ball on the display device.

### TECHNICAL FIELD

This application relates in general to a system and method for providing a sports computing device, and more specifically, to a system and method for providing active golf ball location tracking.

### BACKGROUND

Anyone who golfs loses golf balls during play. Looking for the missing ball delays the game and annoys players. Until now, there has been no way to easily locate the golf ball. The proposed solution can also be repackaged and reconfigured to track other easily lost items such as pets, handbags, bicycles, keys, phones, and various other items that lend themselves to a microchip attachment.

Therefore, a need exists for a system and method for providing active golf ball location tracking. The present invention attempts to address the limitations and deficiencies in prior solutions according to the principles and example embodiments disclosed herein.

### SUMMARY

In accordance with the present invention, the above and other problems are solved by providing a system and method for active golf ball location tracking according to the principles and example embodiments disclosed herein.

In one embodiment, the present invention is a hand-held device for providing active golf ball location tracking, the hand-held device having a memory having instructions stored thereon, a display device, and a processor configured to execute the instructions on the memory to cause the hand-held device to establish a connection with a first golf ball among the plurality of golf balls, load a data buffer containing a unique ID into the first golf ball, periodically determine a current position of the first golf ball until the current position begins to change, receive cellular network tower signals associate with the first golf ball, periodically triangulate a moving position of the first golf ball using the cellular network tower signals, when the moving position of the first golf ball stops changing, determine a range and direction of the first golf ball from the hand-held device; and display the range and direction of the first golf ball on the display device.

In another aspect of the present invention, the processor further periodically calculates a current range and direction of the first golf ball from the hand-held device, updates the range and direction of the first golf ball on the display device to the current range and direction, and provide an auditory signal based upon the current range and distance.

In another aspect of the present invention, the hand-held device connects to the first golf ball to load the unique ID using a Bluetooth™ connection.

In another aspect of the present invention, the data buffer comprises a 64-bit word and the data buffer contains the unique ID and a golf ball number.

In another aspect of the present invention, the range data on the display device comprises a numerical distance value and the direction data on the display device comprises a graphic directional indication indicating an angle of deflection from a centerline of the hand-held device.

In another aspect of the present invention, auditory signal comprises a periodic auditory signal, the periodic auditory signal having an active phase and an inactive phase.

In another aspect of the present invention, a first time period of the active phase of the periodic auditory signal remains constant and a second time period of the inactive phase of the periodic auditory signal is determined by the current range of the first golf ball from the hand-held device.

In another embodiment, the present invention is a method for providing active golf ball location tracking, the method establishes a connection with a first golf ball among the plurality of golf balls, loads a data buffer containing a unique ID into the first golf ball, periodically determines a current position of the first golf ball until the current position begins to change, receives cellular network tower signals associate with the first golf ball, periodically triangulates a moving position of the first golf ball using the cellular network tower signals, determines a range and direction of the first golf ball from the hand-held device when the moving position of the first golf ball stops changing, and displays the range and direction of the first golf ball on the display device.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrates an example embodiment of a system and method for providing active golf ball location tracking according to the present invention.

FIGS. 2a-b illustrate golf balls that are part of a system and method for providing active golf ball location tracking according to the present invention.

FIG. 3 illustrates a computing device connecting with a golf ball using a system and method for providing active golf ball location tracking according to the present invention.

FIG. 4 illustrates additional example display screens from a computing device used with a system and method for providing active golf ball location tracking according to the present invention.

FIG. 5 illustrates a set of additional screens provided by a hand-held device for providing active golf ball location tracking according to the present invention.

FIGS. 6a-b illustrates a computing system of hardware and software components within a system and method for providing active golf ball location tracking according to the present invention.

FIG. 7 illustrates a flowchart corresponding to a method performed by software components of a system and method for providing active golf ball location tracking according to the present invention.

FIG. 8 illustrates a generalized schematic of a programmable processing system utilized as the various computing components described herein to implement an embodiment of the present invention.

### DETAILED DESCRIPTION

This application relates in general to a system and method for providing a sports computing device, and more specifically, to a system and method for providing active golf ball location tracking according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components, but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using a system and method for providing active golf ball location tracking according to the present invention. The term user herein refers to one or more users and golfers.

The term “invention” or “present invention” refers to the invention being applied for via the patent application with the title “Golf Ball Location Tracking System and Method.” Invention may be used interchangeably with device.

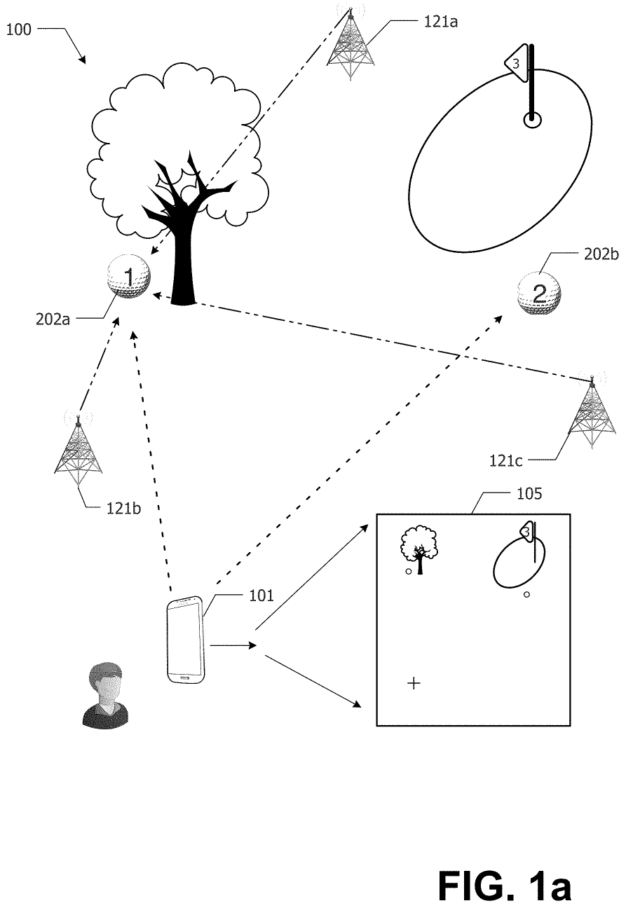

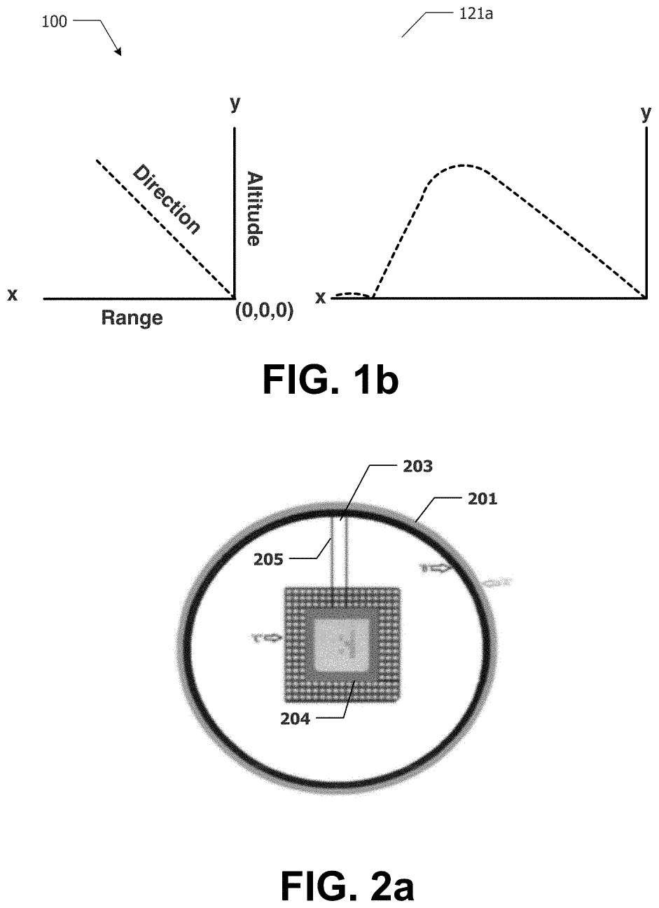

In general, the present disclosure relates to a system and method for providing active golf ball location tracking according to the present invention. To better understand the present invention, FIGS. 1a-b illustrates an example embodiment of a system and method for providing active golf ball location tracking according to the present invention. In FIG. 1a, a group of golfers proceeds to engage in a round of golf on a particular course. At each hole, the golfers hit their respective gold balls 202a-b towards a pin 107 on a green 108. After each shot has been taken, the golfers must find where their respective golf balls 202a-b have come to rest.

In a preferred embodiment, the golf ball tracking system 101 is used by professional golfers. Professional golfers use premium balls; and they discard the ball after each game. As such, the golf ball tracking system 101 will not need to be concerned with recharging the golf balk used with the system 101.

The golf ball location tracking device 101 may be utilized to communicate wirelessly with specially outfitted golf balls 202a-b to guide the golfers to their golf balls. The golf ball location tracking device 101 may provide both a distance to a ball being tracked as well as an estimate for the distance to that golf ball. Using the golf ball location tracking device 101, the golfers may easily proceed to the golf balls to continue to play the hole. In a preferred embodiment, the golf ball location tracking device 101 actively tracks a single golf ball 202a-b at a time. Each golfer would use his or her own golf ball location tracking device 101.

As shown in FIG. 1b, the golf ball location tracking device 101 tracks a golfer's golf ball 202a-b from to point of origin (when golfer strikes the ball), to the point when golf ball comes to complete stop. To assist the golfer in finding the ball, an arrow in the golf ball location tracking device 101 points in the direction of the golf ball, displays the distance in feet, and triggers an audible tone at 2 second intervals as the user gets closer to the golf ball the audible tone speeds up until coming to a full steady tone when user is at the ball. Beyond guiding the golfer to the golf ball, the golf ball location tracking device 101 performs a variety of other functions to provide useful data to the golfer: golf ball tracking begins from the moment the golfer strikes the golf ball and terminates when ball comes to full stop; the golf ball location tracking device 101 pings cell towers 121a-c to triangulate, to accurately plot the flight path of the golf ball. When tracking terminates, the golf ball location tracking device 101 displays a graphic screen that displays the flight path of the golf ball from point of origin to point of golf ball coming to a full stop. On that same screen, device displays a Time in flight/Distance the ball traveled in the air before hitting the ground, and a total time to full stop/Total distance traveled.

The golf ball location tracking device 101 uses triangulation to track the golf ball location throughout the flight of the golf ball, from point of origin (where the golfer is standing), to point where ball comes to a stop. The device pings cell towers to triangulate on signal being transmitted by the golf ball. The golf ball location tracking device 101 is using triangulation to find the X, Y, Z components of the golf ball from the signal being transmitted perhaps at intervals of 100 ms and make the calculations in the software from the X, Y, Z components. In our case:
X—Distance: 0-650 feet/Range
Y—Height/Altitude
Z—The Z component is that final component the lets us identify the exact location of the ball in 3 dimensional space, it tells the needle on the device where to point with reference to the user standing at the origin X=0, Y=0, Z=0!

Triangulation is the process of finding those 3 coordinates In the electronics/software uses the (X,Y,Z) coordinate obtained, the golf ball location tracking device 101 can extract all data needed. The golf ball location tracking device 101 can accurately plot golf balls flightpath within a range of 0 to 850 feet Maximum on the 2 dimensional plane (X, Y), and crunch data to get time stamp and distance stamp. The best professional golf players, hitting the ball beyond 850 feet is unheard of. So we set Max range to 850. Next, electronically, the golf ball location tracking device 101 knows the point of origin (where the golfer is standing). On the 2 dimensional plane X,Y the golf ball location tracking device 101 can plot points along the flightpath of the ball using triangulation data. This process has been used with aircraft data since the 70's at 100 ms intervals. The transmitter on the microchip is broadcasting a signal at 100 ms intervals, 100 times per second. The device can ping local cell towers to triangulate and track the ball at that same frequency.

In some embodiments of the golf ball location tracking device 101, a local course map 105 also may be presented on a display screen of the golf ball location tracking device 101 in which the location of the balls being tracked is shown with points on the hole shown in reference to the golfers' location. For example, a golfer hits a shot with his golf ball 202a behind a tree marked on the local course map 105 may readily see the ball's location relative to the tree. This additional information my assist the golfers to find their golf balls 202a-b more quickly. The local course map 105 may show all of the major obstacles on a particular hole, such as fairways and roughs, sand traps, water, and other brush that typically makes finding a golf ball challenging.

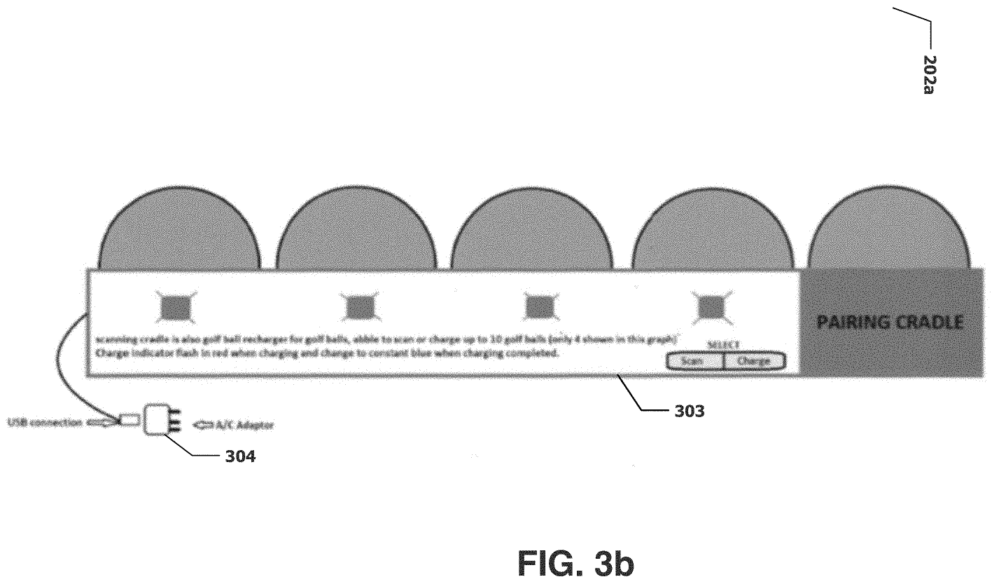

The golf ball location tracking device 101 is implemented, in a preferred embodiment, as an electronic computing device having a display to show a map or at least provide directions to the balls being tracked as disclosed herein. The golf ball location tracking device 101 may utilize known wireless communications methods to locate the golf ball 202a-b with respect to the golf ball location tracking device 101 and the golfers. The computing device may be implemented as a stand-alone and special purpose device that permits the golf ball location tracking device 101 to communicate with specially prepared golf balls to provide the needed location, direction, and distance from the golfers to the balls. Alternatively, the golf ball location tracking device 101 also may be implemented using a smartphone or similar computing device that includes all of the components described herein after a mobile application has been downloaded onto the smartphone. In order for a particular smartphone to operate as the golf ball location tracking device 101 when executing the mobile application, the smartphone must have the components disclosed herein with respect to FIG. 3-7 below. The golf ball location tracking device 101 may track a single golf ball or multiple golf balls played by a foursome when all of the balls have been prepared to operate as disclosed herein.

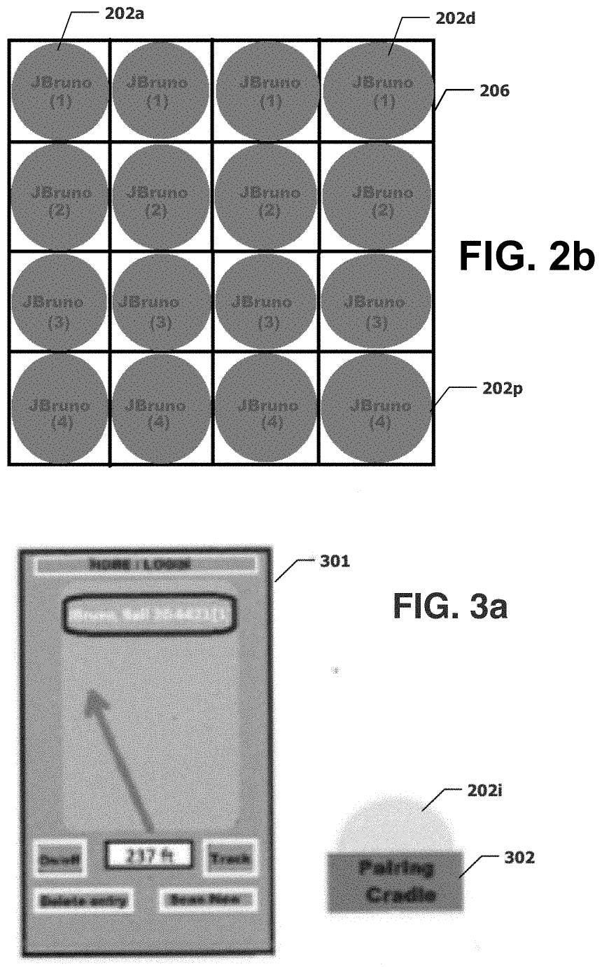

FIGS. 2a-b illustrate golf balls that are part of a system and method for providing active golf ball location tracking according to the present invention. FIG. 2a shows a half of a golf ball 201 to show the chip 204 and associated components. The microchip 204 is of the type used in devices such as Black Boxes. Battery powered microchip is installed inside golf ball in manufacturing process. The golf ball 201 of FIG. 2a has an outer layer 203, an inner layer of wire 205 for wireless charging of the battery, and the microchip 204. Specially designed battery of similar size and shape of microchip in centered inside golf hall to ensure equilibrium, microchip and hand-held device have a buffer to store pairing data; to ensure device only tracks ball paired to the device. In doing this, we ensure all devices will only track that golf ball paired by each individual golfer.

FIG. 2b shows a package of golf balls numbered 1-10 that can be custom ordered to include a user's name, i.e. JBruno (1), JBruno (2) etc. Balls appear on screen as each ball is placed in a pairing cradle and the user selects SCAN NEW. Each unit stores 10 balls.

FIGS. 3a-b illustrates a computing device connecting with a golf ball using a system and method for providing active golf ball location tracking according to the present invention. FIG. 3a shows a track display screen 301 where a distance in feet appears in a window 311 and a needle 312 points to a current ball location. An audible beep may be generated at an initial 2-second interval that speeds up as the user gets closer to the ball being tracked. The audible beep may become a continuous tone when the user is at the location of the ball. The golf ball location tracking device 101 is a handheld device is about the size of an iPhone. The handheld device also has 64 bit word buffer as shown in FIG. 5 below. First 4 bits reserved to store ball number, bits 5-64 stores unique code assigned to each machine manufactured. A pairing cradle is a device can store up to 10 golf balls to keep in memory. Balls 202i to be scanned into device are placed in pairing cradle 302, and although pairing is done wirelessly, only the ball placed in pairing cradle is recognize by device as current ball to be scanned. FIG. 3b shows an embodiment of a cradle 303 capable of holding multiple golf balls. These golf balls may be scanned as noted above as well as recharged the internal batteries from an external power source using a connecting plug 304 while in the cradle 303.

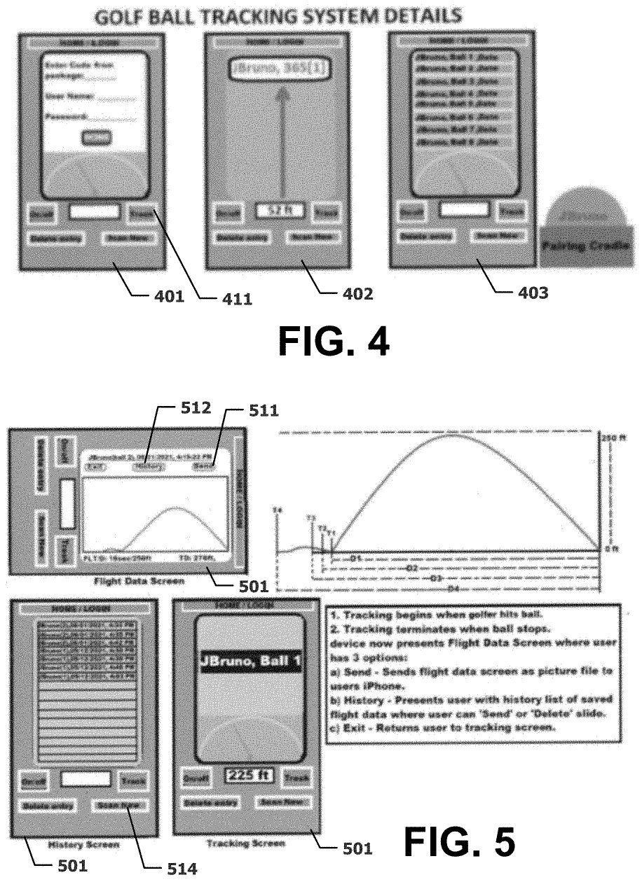

FIG. 4 illustrates additional example display screens from a computing device used with a system and method for providing active golf ball location tracking according to the present invention. FIG. 4 shows a user login screen display 401. A user is initially prompted to enter a code that accompanies the package and enables the user to select a username and password. The home screen initially is blank. When a user taps on a particular ball on the screen display 403, the remaining balls disappear from the screen. The user then can select either a TRACK user control or a DELETE user control to provide user commands. The TRACK user control presents a track display screen 402 where a distance in feet appears in the window and a needle points to the ball location. Audible beeping at 2-second intervals speeds up as the user gets closer to the ball and becomes a continuous tone when the user is at the ball. A DELETE user control may be used when a user has lost a ball, ie. ball 5, (perhaps it fell off a cliff). The user deletes the ball 5 entry, places a new ball 5 in the pairing cradle, and selects SCAN NEW to identify a new ball 5.

An additional user control may include an ON/OFF control to start and turn off a golf ball tracking system. Other possible user controls (not shown) may include COURSE DISPLAY to display a map of a course showing an approximate location of the user and an approximate location of the ball being tracked. The golf ball location tracking system may obtain maps and corresponding locations for each hole on a course being played and use these maps to generate these displays. The map for each hole also may save all positions of the ball being tracked, and corresponding time stamps, for a given date in order to later display these locations for an entire round of golf.

FIG. 5 illustrates a set of additional screens provided by a hand-held device for providing active golf ball location tracking according to the present invention. These additional screens include a Flight Data Screen 501, a History Screen 502, and a Track Screen 503. The user selects the Track control 411 to return a user to Tracking screen 503. When Tracking is completed, the device presents ‘Flight Data Screen’ 501 to direct the user to the golf ball. From the Flight Data Screen 501, user has 3 options: a) use the Send control 512 that sends graphic slide of Flight Data Screen 501 a user's iPhone; b) use a History control 512 to displays list of all saved flight data; and c) Delete Entry control 513 to delete a current Flight Data Selected. Additional controls include a Scan New control 514 to permit a user to place a ball to be paired in Pairing Cradle and press Scan New control 514 to pair the ball with the golf ball tracking system. The device also forgets a previous paired ball. Additionally, a Battery level slide bar displays a current battery level for the golf ball tracking system.

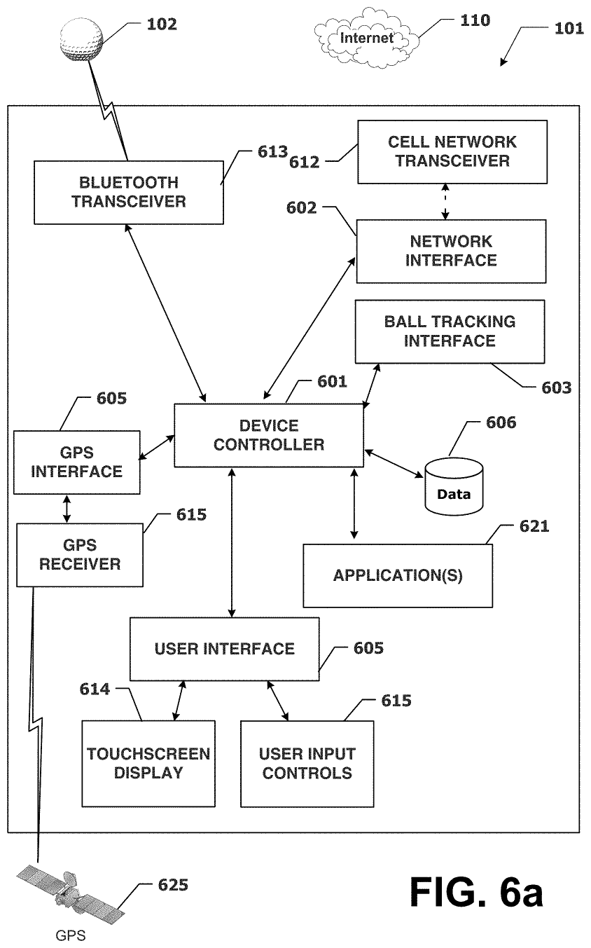

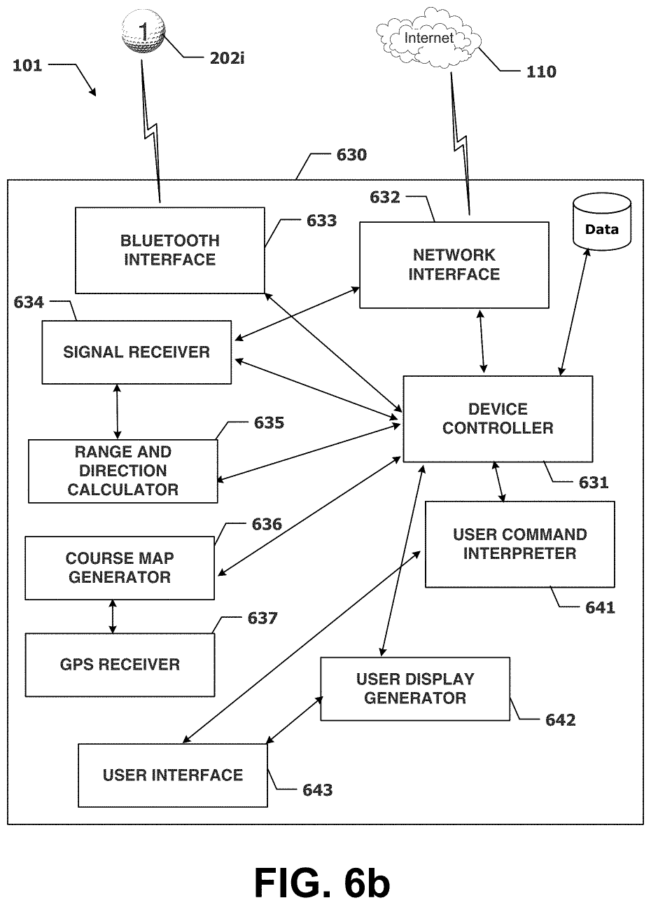

FIGS. 6a-b illustrates a computing system of hardware and software components within a system and method for providing active golf ball location tracking according to the present invention. FIG. 6a shows a computing system of hardware components within a system and method for providing active golf ball location tracking according to the present invention. The golf ball tracking device 101 includes a set of hardware components to be included within the golf ball tracking device 101 to provide its functionality. The set of hardware components comprises a device controller 601, a cell network interface 602 supporting a network communications transceiver 612, a ball tracking interface 603 coupled to the cell network transceiver 612, a user interface 604 controlling a touch screen display 614 and related user input controls 615, a GPS interface 605 communicating with a GPS receiver 615, and a local datastore 606. As noted with respect to FIG. 1, these components may be included within a commercially available smartphone, for example an iPhone™ and an Android™ phone where the invention is contained within executable code that is part of an application that executes this code using the smartphone. Alternatively, a standalone golf tracking device 101 may be constructed containing the above listed components.

The device controller 601 is a programmable processing device such as a microprocessor with its associated memory to execute the instructions of the application 601. The device controller 601 provides commands and control signals to other components of the golf ball location tracking device 101 to control these components operation as needed.

The cell network interface 602 supporting a network communications transceiver 612 is a combination of data storage and signal transmitted to permit data from the device controller 501 to be transmitted to remote computing devices over the Internet 110. The web interface 602 supporting a cell network communications transceiver 612 performs a similar function to receive data from remote sources for use by the device controller 601 and other hardware and software components.

The ball tracking interface 603 is coupled to cell network transceiver 612 to receive cell tower data to determine the position of the golf ball in flight. The ball tracking interface 603 interacts with a range and direction calculator 634 as disclosed below with respect to FIG. 6b to determine the position of the golf ball using triangulation as disclosed above.

The user interface 604 controlling a touch screen display 614 and related user input controls 615 provides a signal path and signal generation and reception needed to output display screens to the touchscreen device 614 as well as receives input signals from the touch screen display 615 and other user input controls 615 including switches and buttons on the golf ball location tracking device 101.

The GPS interface 605 communicating with a GPS receiver 615 provides a signal path for GPS location data received within the GPS receiver 615 for use by the device controller 601 and other hardware and software components.

The Bluetooth™ transceiver 613 is coupled to the device controller 601 to permit the device controller 601 to communicate with the paring cradle 302 when configuring and connecting the golf ball tracking device 101 to golf balls 202i.

The local datastore 606 provides semi-permanent data storage within the golf ball location tracking device 101.

FIG. 6b shows a computing system of software components within a system and method for providing active golf ball location tracking according to the present invention. The software components 630 contain a set of encoded executable instructions within an application program, within microcode stored within the golf location tracking device 101, and a combination of the two forms of instructions. These executable instructions may be downloaded from a remote computing device such as a web server each time the golf location tracking device 101 is activated. These executable instructions also may be stored within the datastore 606 for use when the golf location tracking device is active. The set of software components 630 comprises a device controller 631, a web interface 632, a Bluetooth™ interface, a signal receiver 634, a range and direction calculator 634, a course map generator 636, a GPS position calculator 637, a user display generator 642, and a user interface 643.

The device application 631 provides the basic set of instructions to perform the functions of the golf ball location tracking device 101. The device application 631 communicates with the remaining software components 631-643 to complete its operation. The device application 631 utilizes the processing within these software components for providing focused processing of data related to a particular function.

The cell network interface 632 golf ball location tracking device 101 communicates with cell towners to reach both golf balls 202i and remote computing devices such as software web servers, course map data servers, user score recording data servers, and related web servers. The cell network interface 632 also performs all of the data formatting, computer-to-computer communications, encryption processing, and all similar operations needed by the web server to communicate with users.

The Bluetooth™ interface 633 permits the computing components 632-643 to communicate with the pairing cradle 302 and attached gold balls 202i. The Bluetooth™ interface 633 all of the data formatting, computer-to-computer communications, encryption processing, and all similar operations needed by the device controller 631 to communicate with golf balls 202a-n.

The signal receiver 634 receives the cell tower signals received from the golf ball 202i and generates location data to be used by the range and direction calculator 634. The signal receiver 634 performs all formatting and data transformation needed to transform input signals from the cell network interface 632 needed by the range and direction calculator 634.

The range and direction calculator 634 obtains location data associated with the golf ball being tracked to determine both a direction and a distance between the golf ball being tracked and the golf ball location tracking device 101. The range and direction calculator 634 performs the triangulation calculations as disclosed above with respect to FIG. 1.

The course map generator 636 generates a display screen of the current hole being played that includes the location of the golf ball location tracking device 101, the golfers, and the ball being tracked. Using course map data downloaded for the course before play begins may allow the course map generator 636 to show fairways, greens, sand traps, trees and rough for the hole. The course map generator 636 generates a map for a given hole based upon a current location of the golf ball location tracking device 101 and superimposes the location of the golfers and the golf ball location tracking device 101 as well as the ball being tracked.

The GPS position calculator 637 receives GPS data from the GPS receiver 516 to generate a current position of the golf ball location tracking device 101. The GPS position calculator 637 performs any needed data calculations to determine a current position relative to the course map of the hole being played and other location calculations used within the golf ball location tracking device 101.

The user display generator 642 responds to user commands to generate a new display screen to be shown on the touchscreen display 614. The user display generator 642 generates each of the standard display screens used by the golf ball location tracking device 101. The user display generator 642 may generate visual representations of a local position map generated within the course map generator 636 that are viewable on the touchscreen display 619. The user display generator 642 transmits display data to the user interface 643 for output to the user.

The user interface (UI) 643 provides input and output processing to provide a driver with messages and data needed to perform the location calculations, position and display map generation, stat storage operation, and receiving user commands. This user interface module 643 also accepts commands from the golfer to instruct the application to perform these tasks.

The user interface 643 and the user display generator 642 combine to provide a set of UI screens that contain commands that permit the golfer to interact and command the golf ball location tracking device 101. These commands, as previously described above with reference to FIGS. 4-5. include:
a. ON/OFF—Self explanatory
b. Track: From whatever screen, ‘Track’ returns user to Tracking screen.
c. When Tracking is completed, device presents ‘Flight Data Screen’.
d. From ‘Flight Data Screen’, user has 3 options:
   1. Send—Sends graphic slide of ‘Flight Data Screen to users iPhone.
   2. History—Displays list of all saved flight data.
   3. Delete—Deletes current Flight Data Selected.
d) To pair golf ball location tracking device 101 to iPhone: With golf ball location tracking device 101 turned ‘On’, user looks for ‘Golf Ball Tracker’ on iPhone for pairing.
e) Scan New: User places ball to be paired in pairing cradle, pressing ‘Scan New’ pairs ball to device. A user can pair up to 10 golf balls in turn. If a golf ball is lost, let us say golf ball(2) fell in a lake, user would delete golf ball(2) from device and pair a new golf ball(2).
f) Delete: Deletes current Flight Data Selected.

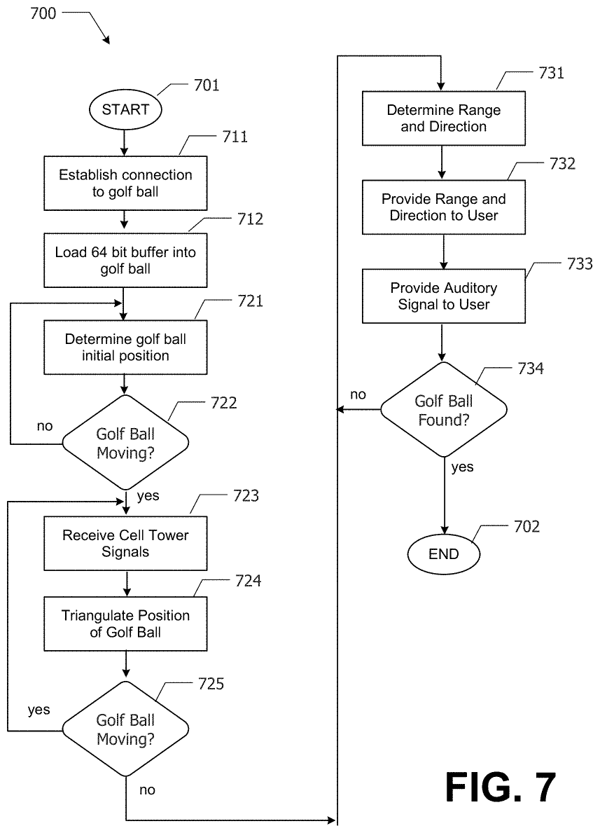

FIG. 7 illustrates a flowchart corresponding to a method performed by software components of a system and method for providing active golf ball location tracking according to the present invention. The process 700 begins 701 when the golf ball location tracking device 101 establishes a connection to a golf ball 202i while in the pairing cradle 302 in step 711. Once connected, the golf ball location tracking device 101 loads a 64 bit unique identifier into the golf ball 202i in step 712 to enable the secure identification and communications between the golf ball location tracking device 101 and the golf ball. The golf ball location tracking device 101, during a round of golf in step 721, determines an initial position of the golf ball 202i as the golfer is preparing to take a next shot.

In test step 722, the golf ball location tracking device 101 determines whether the golf ball 202i is moving. The first movement detected for the golf ball 202i indicates that the golfer has taken a shot and the golf ball 202i is in flight. If test step 722 determines that the ball is not moving, the process 700 returns to step 721 until motion of the golf ball is detected. When test step 722 determines that eth golf ball 202i is now in motion, the golf ball location tracking device 101 receives cell tower signals in step 723 and triangulates the position of the golf ball 202i in flight in step 724. in test step 725, the golf ball location tracking device 101 determines whether the golf ball 202i is still in flight, and if so, the process 700 returns to step 723 until the golf ball comes to rest.

When test step 725 determines that the golf ball is no longer moving, the golf ball location tracking device 101 determines the range to the golf ball 202i and its relative direction in step 731. The golf ball location tracking device 101 provides a UI screen indicating the determined direction and range to the golfer in step 732 and provides an auditory signal indicating the distance to the golf ball in step 733. Test step 734 permits the golf ball location tracking device 101 to determine whether the golfer has indicated that the golf ball has been found; and if not, the process 700 returns to step 731 until the golf ball 202i is located. When the golf ball location tracking device 101 determines in step 734 that the golf ball has been found, the process 700 ends 702 until the golfer is ready to take a next shot during the round of golf, at which time the entire process 700 may begin again.

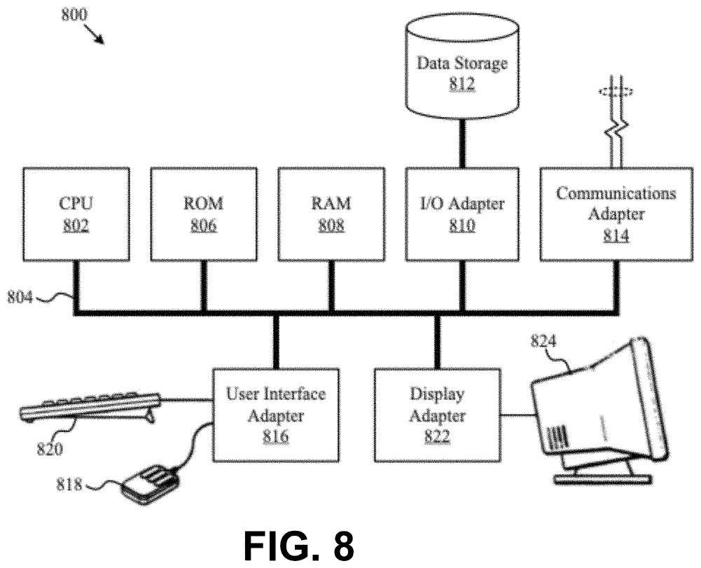

FIG. 8 illustrates a generalized schematic of a programmable processing system utilized as the various computing components described herein used to implement an embodiment of the present invention. FIG. 8 shows a computer system 800 adapted according to certain embodiments of the server and/or the user interface device. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The communications adapter 814 may also be adapted to couple the computer system 800 to other networks such as a global positioning system (GPS) or a Bluetooth network. The user interface adapter 816 couples user input devices, such as a keyboard 820, a pointing device 818, and/or a touch screen (not shown) to the computer system 800. The keyboard 820 may be an on-screen keyboard displayed on a touch panel. Additional devices (not shown) such as a camera, microphone, video camera, accelerometer, compass, and or gyroscope may be coupled to the user interface adapter 816. The display adapter 822 may be driven by the CPU 802 to control the display on the display device 824. Any of the devices 802-822 may be physical and/or logical.

The applications of the present disclosure are not limited to the architecture of the computer system 800. Rather the computer system 800 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A hand-held device for providing active golf ball location tracking, the hand-held device configured to communicatively connect the hand-held device, plurality of golf balls, and a plurality of cellular network transmission towers, the hand-held device comprising:
a memory having instructions stored thereon;
a display device; and
a processor configured to execute the instructions on the memory to cause the hand-held device to:
establish a connection with a first golf ball among the plurality of golf balls;
load a data buffer containing a unique ID into the first golf ball;
periodically determine a current position of the first golf ball until the current position begins to change;
receive cellular network tower signals associate with the first golf ball;
periodically triangulate a moving position of the first golf ball using the cellular network tower signals;
when the moving position of the first golf ball stops changing, determine a range and direction of the first golf ball from the hand-held device; and
display the range and direction of the first golf ball on the display device.

2. The hand-held device according to claim 1, wherein the processor further executes instructions to cause the hand-held device to further:
periodically calculate a current range and direction of the first golf ball from the hand-held device;
update the range and direction of the first golf ball on the display device to the current range and direction; and
provide an auditory signal based upon the current range and distance.

3. The hand-held device according to claim 2, wherein the hand-held device connects to the first golf ball to load the unique ID using a BLUETOOTH connection.

4. The hand-held device according to claim 2, wherein the data buffer comprises a 64-bit word; and
the data buffer contains the unique ID and a golf ball number.

5. The hand-held device according to claim 2, wherein the range data on the display device comprises a numerical distance value; and
the direction data on the display device comprises a graphic directional indication indicating an angle of deflection from a centerline of the hand-held device.

6. The hand-held device according to claim 5, the auditory signal comprises a periodic auditory signal, the periodic auditory signal having an active phase and an inactive phase.

7. The hand-held device according to claim 6, a first time period of the active phase of the periodic auditory signal remains constant; and
a second time period of the inactive phase of the periodic auditory signal is determined by the current range of the first golf ball from the hand-held device.

8. A method for providing active golf ball location tracking using a hand-held device, the hand-held device configured to communicatively connect the hand-held device, one or more golf balls, and a plurality of cellular network transmission towers, the method comprises:
establishing a connection with a first golf ball among the plurality of golf balls;
loading a data buffer containing a unique ID into the first golf ball;
periodically determining a current position of the first golf ball until the current position begins to change;
receiving cellular network tower signals associate with the first golf ball;
periodically triangulating a moving position of the first golf ball using the cellular network tower signals;
when the moving position of the first golf ball stops changing, determining a range and direction of the first golf ball from the hand-held device; and
display the range and direction of the first golf ball on the display device.

9. The method according to claim 8, wherein the method further comprising:
periodically calculating a current range and direction of the first golf ball from the hand-held device;
updating the range and direction of the first golf ball on the display device to the current range and direction; and
providing an auditory signal based upon the current range and distance.

10. The hand-held device according to claim 9, wherein the hand-held device connects to the first golf ball to load the unique ID using a BLUETOOTH connection.

11. The hand-held device according to claim 9, wherein the data buffer comprises a 64-bit word; and
the data buffer contains the unique ID and a golf ball number.

12. The hand-held device according to claim 9, wherein the range data on the display device comprises a numerical distance value; and
the direction data on the display device comprises a graphic directional indication indicating an angle of deflection from a centerline of the hand-held device.

13. The hand-held device according to claim 12, the auditory signal comprises a periodic auditory signal, the periodic auditory signal having an active phase and an inactive phase.

14. The hand-held device according to claim 13, a first time period of the active phase of the periodic auditory signal remains constant; and
a second time period of the inactive phase of the periodic auditory signal is determined by the current range of the first golf ball from the hand-held device.

15. A non-transitory computer-readable recording medium in for providing active golf ball location tracking, the hand-held device configured to communicatively connect the hand-held device, plurality of golf balls, and a plurality of cellular network transmission towers, the non-transitory computer-readable recording medium storing one or more programs which when executed by a controller of the hand-held device performs steps comprising
establishing a connection with a first golf ball among the plurality of golf balls;
loading a data buffer containing a unique ID into the first golf ball;
periodically determining a current position of the first golf ball until the current position begins to change;
receiving cellular network tower signals associate with the first golf ball;
periodically triangulating a moving position of the first golf ball using the cellular network tower signals;
when the moving position of the first golf ball stops changing, determining a range and direction of the first golf ball from the hand-held device;
display the range and direction of the first golf ball on the display device;
periodically calculating a current range and direction of the first golf ball from the hand-held device;
updating the range and direction of the first golf ball on the display device to the current range and direction; and
providing an auditory signal based upon the current range and distance;
wherein the direction data on the display device comprises a graphic directional indication indicating an angle of deflection from a centerline of the hand-held device;
the auditory signal comprises a periodic auditory signal, the periodic auditory signal having an active phase and an inactive phase;
a first time period of the active phase of the periodic auditory signal remains constant; and
a second time period of the inactive phase of the periodic auditory signal is determined by the current range of the first golf ball from the hand-held device.
